(19) United States
(12) Patent Application Publication
(10) Pub. No.: US 2020/0171940 A1
(43) Pub. Date: Jun. 4, 2020

(54) PARKING BRAKE SYSTEM FOR A MOTORIZED VEHICLE AND MOTORIZED VEHICLE

(71) Applicant: ZF Active Safety GmbH, Koblenz (DE)

(72) Inventors: Benedikt Ohlig, Vallendar (DE); Erwin Michels, Kail (DE)

(73) Assignee: ZF Active Safety GmbH, Koblenz (DE)

(21) Appl. No.: 16/614,506

(22) PCT Filed: May 18, 2018
(86) PCT No.: PCT/DE2018/100483

§ 371 Date: Nov. 18, 2019

(30) Foreign Application Priority Data
May 19, 2017 (DE) 10 2017 110 942.0

(51) Int. Cl. B60K 17/04; B60T 1/06; B60T 1/00; F16H 37/08; B60K 17/16; F16H 63/34; B60T 13/74

(52) U.S. Cl. CPC B60K 17/043; B60T 1/065; B60T 1/005; F16H 37/0813; F16H 2702/02; F16H 63/3416; B60T 13/746; F16H 63/3466; B60T 1/062; B60K 17/165

(57) ABSTRACT

The invention relates to a parking brake system for a motorized vehicle, which uses a drive train. Furthermore, the invention relates to a drive train for a motorized vehicle, comprising a transmission drivingly couplable with a drive machine and a differential operatively connected to a output shaft of the transmission, wherein the differential has a transmission housing, a transmission input, two transmission output shafts, and a rotary gear transmission. The transmission input is operatively connected to the output shaft of the transmission and the transmission output shafts are each input-connectable to a vehicle wheel. With the drive train, at least two brake elements are provided for a parking brake, of which a first brake element is used for locking one of the transmission output shafts of the differential and a second brake element for locking the transmission input of the differential.

### CROSS-REFERENCE TO RELATED APPLICATION

This application is a national stage of International Application No. PCT/DE2018/100483, filed May 18, 2018, the disclosure of which is incorporated herein by reference in its entirety, and which claimed priority to German Patent Application No. 102017110942.0, filed May 19, 2017, the disclosure of which is incorporated herein by reference in its entirety.

### TECHNICAL FIELD

The invention relates to a parking brake system for a motorized vehicle. Furthermore, the invention relates to a motorized vehicle with such a parking brake system.

### BACKGROUND

Parking brakes, also called emergency brakes, are used in motorized vehicles, for example. They are generally provided to keep the motorized vehicle at standstill, for example, if the motorized vehicle is stopped on an inclined roadway. The parking brakes are also generally designed to keep the motorized vehicle at standstill for a longer period of time, for example, in the absence of the driver.

The parking brakes are usually applied to an axle on the wheels of the motorized vehicle and are implemented there in the area of the wheel hubs, for example, as a drum brake or a disc brake. When drum brakes are used as parking brakes, parts of the service brake are frequently used jointly, for example, when in a service brake designed as a disc brake the inner peripheral surface of the brake disc pot serves as a friction surface for the brake pads of the drum brake. These parking brakes have in common that a separate brake is provided for each wheel to lock the wheel and, as a result, park the motorized vehicle and each of the brakes is dose to the corresponding wheel, so-called wheel brakes.

### SUMMARY

One object of the invention is to suggest at least one alternative for allowing parking for example for a motorized vehicle. This object is solved by a parking brake system, which has the characteristics of claim 10 and uses a drive train with the characteristics of claim 1. Furthermore, this object is solved by suggesting a method to operate a parking brake system with the characteristics of claim 13 as well as a method to operate a parking brake system with the characteristics of claim 14. In addition, the object is solved by suggesting a motorized vehicle with the characteristics of claim 15 and a use with the characteristics of claim 16. Advantageous embodiments and/or configurations and/or aspects of the invention arise from the subclaims, the following description, and the figures.

A basic parking brake system, e.g. for a motorized vehicle, uses a drive train. A possible embodiment of a drive train, which can be used by a parking brake system, is a drive train for a motorized vehicle, comprising a transmission drivingly couplable or coupled to a drive machine and a differential operatively connected or connectable to a drive train of the transmission.

The transmission is specifically defined as a transmission, which is designed to cause a single transmission ratio or different transmission ratios between its input or input shaft and its output or output shaft or pinion shaft. The transmission can be configured for manual operation or for an automated operation. For example, the transmission is a manual transmission or an automated transmission or a converter-automated transmission or a continuously variable transmission or a semiautomatic transmission or a transmission with a converter clutch.

The differential can be an axle differential. The axle differential can be a front axle differential or a rear axle differential. The differential consists of a transmission housing, a transmission input, two transmission output shafts, and a rotary gear transmission, by which the transmission output shafts are in operative connection with the transmission input. The rotary gear transmission, for example, distributes the drive power operating at the transmission input to the transmission output shafts. The transmission input is operatively connected to the output shaft of the transmission and the transmission output shafts are each input-connectable or input-connected to a vehicle wheel.

In particular, the transmission housing of the differential is configured to be built into the drive train, specifically to be firmly fixed to a housing of the drive train and/or to a housing of the manual transmission, and/or to be fixed by a vehicle chassis to the housing. For example, the transmission housing of the differential has at least one connecting element or coupling element for this purpose. The transmission has been specifically designed to be input-connected to a drive machine, such as an internal combustion engine or an electric motor. For example, the transmission has at least one connecting element or coupling element for this purpose. The transmission can be a manually operable transmission or an automatically operable transmission, such as an automatic transmission or a semiautomatic transmission.

For example, the rotary gear transmission has at least four transmission elements consisting of two transmission elements as the central gear, at least one transmission element as a rotary gear, and one transmission element as a rotary gear carrier. For example, the rotary gear carrier is coupled with the transmission input and one of the central gears each with one of the transmission output shafts. For example, at least one rotary gear is engaged with the central gears and is pivotably mounted to the rotary gear carrier. Specifically, the rotary gear carrier is pivotably supported against at least one of the transmission output shafts.

At the drive train, according to an embodiment, at least two brake elements are designed for a parking brake of which a first brake element, specifically one single first brake element, is used for locking one of the transmission output shafts of the differential and a second brake element, specifically one single second brake element, is used for locking the transmission input of the differential. As a result, aside from the function as a differential, the differential has an additional function with regard to locking of the transmission output shafts and, consequently, of the vehicle wheels connected or connectable to it. A parking brake function or an emergency brake function is possible through the differential without having to lock both transmission output shafts by employing the brake elements and, consequently, the vehicle wheels connected or connectable to it. Instead, the existing function inherent in the system of the differential, specifically of the rotary gear transmission, is used allowing the other transmission output shaft to be locked by locking the transmission input, specifically a transmission input shaft, and only one of the transmission output shafts of the differential by employing the brake elements. Consequently, with regard to this other transmission output shaft, a wheel brake with parking brake function usually provided there can be, at any rate, eliminated as to its parking brake function.

The parking brake function or emergency brake function, or parking braking or emergency braking specifically means the locking of one of the transmission output shafts of the differential as well as of the transmission input of the differential by frictional engagement and/or positive engagement using the brake elements to keep the vehicle wheels connected or connectable to both transmission output shafts, for example, of a motorized vehicle at standstill. Specifically, this is to prevent the vehicle from unintentionally rolling away, even if the vehicle is parked on an inclined roadway. The parking brake function can basically also be used for emergency braking of the vehicle. The brake elements can also be called parking elements, since they are used for locking the transmission input and one of the transmission output shafts in the course of parking braking or emergency braking.

Provision may be made that only the two brake elements are provided to lock one of the transmission output shafts and the transmission input of the differential. This measure, among other things, is directed towards implementing the parking brake function or emergency brake function by using relatively few components.

The brake elements can directly or indirectly have an effect on it when locking the one transmission output shaft and the transmission input of the differential, e.g. via at least one intermediate link or several intermediate links. For example, it is provided according to an embodiment that a wheel brake is allocated to each of the transmission output shafts, which is set up for performing a service brake function, wherein one of the wheel brakes is allocated to the first brake element when the wheel brake has a caliper-integrated parking brake, for example. In this case, the parking brake function of the first brake element is operated by the one wheel brake, which can be a regular conventional wheel brake, for example.

For the first brake element to cause a braking action, a drive is provided for actuating the first brake element according to a configuration of the drive train. For example, the drive is allocated to the one wheel brake, to which the first brake element is also allocated. Specifically, the drive is arranged fixed to a housing with regard to a housing of the one wheel brake, specifically arranged at the housing. This way, the drive is allocated to the wheel brake. For example, the drive forms a preassembled modular unit together with the wheel brake. It is the obvious choice that the drive is an electromotive drive with a secondary single-step or multi-step transmission unit, if necessary. This way, the wheel brake is suitable for running in an electric or electromechanical parking brake system (EPB). For example, the drive includes a controllable and/or adjustable electric motor, by which the braking power affecting the first brake element is variable, specifically continuously variable. Such a controllable and/or adjustable drive is the obvious choice, if the corresponding brake element is a frictionally engaged brake element or friction brake.

According to another possible embodiment of the drive train, it is provided that one of the transmission output shafts can be operatively connected, specifically non-rotatably connected, with the transmission housing of the differential by the first brake element. Specifically, the first brake element is configured to operatively connect, specifically non-rotatably connect, one of the transmission output shafts with the transmission housing of the differential. Therefore, the first brake element is directly allocated to the differential. For example, the first brake element is arranged within the transmission housing of the differential. This will use the transmission housing as enclosure for the first brake element. These measures protect the first brake element from external forces, for example, mechanical and/or chemical forces. This way, possible unstable conditions in regard to the braking action are counteracted, which may occur due to decay and/or non-use over a longer period of time of the parking brake system.

If the rotary gear transmission is completed as described above, the one transmission output shaft can also be indirectly operatively connected, specifically non-rotatably connected, to the transmission housing by the first brake element, for example, via the corresponding central gear. Alternatively, at least the one rotary gear can be operatively connected, specifically non-rotatably connected, to the transmission housing by the first brake element. In this case, the one transmission output shaft can also be operatively connected, specifically non-rotatably connected, to the transmission housing by the first brake element.

In this embodiment of the drive train, for the first brake element to cause a braking action, a drive allocated to the differential is provided for actuating the first brake element according to a configuration of the drive train. Specifically, the first brake element is arranged fixed to a housing with regard to the transmission housing of the differential. For example, the drive forms a preassembled modular unit together with the differential. It is the obvious choice that the drive is an electromotive drive with a secondary single-step or multi-step transmission unit, if necessary. This way, the differential is suitable for running in an electric or electromechanical parking brake system (EPB). For example, the drive includes a controllable and/or adjustable electric motor, by which the braking power affecting the first brake element is variable, specifically continuously variable. Such a controllable and/or adjustable drive is the obvious choice, if the first brake element is a frictionally engaged brake element or friction brake. In principle, the drive can also be a mechanical, hydraulic, electrohydraulic, or pneumatic drive, which is, for example, arranged fixed to a housing with regard to the housing of the differential.

In both of the above embodiments of the drive train, it can be designed that the second brake element is allocated to the transmission and is part of a parking lock function of the transmission or is formed by a parking lock function of the transmission. For example, the transmission is in this case an automatic transmission or a semiautomatic transmission. This will use a function of the transmission to lock the transmission input of the differential during parking braking. Its output shaft can be locked by the parking lock function of the transmission. In turn, the output shaft is operatively connected to the transmission input of the differential so that the lock of the output shaft of the transmission also affects the transmission input of the differential when the parking lock function is activated. For example, the parking lock function of the transmission is formed by a mechanical lock, specifically a rotation lock of the output shaft of the transmission. This measure that a function already provided in the transmission, specifically an operating function, is used, enables saving parts in a parking brake system or emergency brake system.

Alternatively, according to both of the embodiments of the drive train mentioned above, it can be provided that the transmission input can be operatively connected, specifically non-rotatably connected, with the transmission housing of the differential by the second brake element. Specifically, the second brake element is configured to operatively connect, specifically non-rotatably connect, the transmission input with the transmission housing of the differential. Therefore, the second brake element is directly allocated to the differential. For example, the second brake element is arranged within the transmission housing of the differential. This will use the transmission housing as enclosure for the second brake element. These measures protect the second brake element from external forces, for example, mechanical and/or chemical forces. This way, possible unstable conditions in regard to the braking action are counteracted, which may occur due to decay and/or non-use over a longer period of time of the parking brake system.

If the rotary gear transmission is completed as described above, the transmission input can also be indirectly operatively connected, specifically non-rotatably connected, to the transmission housing by the second brake element, for example, via the rotary gear carrier. Alternatively, at least the one rotary gear can be operatively connected, specifically non-rotatably connected, to the transmission housing by the second brake element. In this case, the transmission input can also be operatively connected, specifically non-rotatably connected, to the transmission housing by the second brake element.

In this embodiment of the drive train, for the second brake element to cause a braking action, a drive allocated to the differential is provided for actuating the first brake element according to a configuration of the drive train. Specifically, the first brake element is arranged fixed to a housing with regard to the transmission housing of the differential. For example, the drive forms a preassembled modular unit together with the differential. It is the obvious choice that the drive is an electromotive drive with a secondary single-step or multi-step transmission unit, if necessary. This way, the differential is suitable for running in an electric or electromechanical parking brake system (EPB). For example, the drive includes a controllable and/or adjustable electric motor, by which the braking power affecting the second brake element is variable, specifically continuously variable. Such a controllable and/or adjustable drive is the obvious choice, if the second brake element is a frictionally engaged brake element or friction brake. In principle, the drive can also be a mechanical, hydraulic, electrohydraulic, or pneumatic drive, which is, for example, arranged fixed to a housing with regard to the housing of the differential.

If a drive, specifically an electromotive drive, is provided for actuating the first brake element, the drive can also be used for actuating the second brake element. In this case, the common drive is used for the first brake element and the second brake element. For example, the common drive is arranged fixed to a housing with regard to the transmission housing of the differential.

The first brake element and/or the second brake element can be a frictional engaged brake element. For example, the first brake element and/or the second brake element is a friction brake or an integral part of a friction brake. The friction brake can be a disc brake or a shoe brake. If a disc brake is used, it can be configured as a fixed-caliper disc brake or floating-caliper disc brake. In principle, each kind of friction brake can be used.

If the first brake element and/or the second brake element is a friction brake or an integral part of a friction brake, an embodiment may entail that the brake element has at least one friction surface non-rotatably arranged with regard to the transmission housing of the differential, and the transmission element of the differential that can be operatively connected to the transmission housing of the differential, i.e. the one transmission output shaft or the corresponding central gear or the at least one rotary gear or the rotary gear carrier, has a counter friction surface. The counter friction surface can be designed on a brake disc, which is, for example, moulded to its corresponding transmission element or non-rotatably connected to it.

According to another embodiment, the differential is a spur gear differential. The spur gear differential can have two rotary gears, which are non-rotatably connected to a common shaft rotatably mounted to the rotary gear carrier and arranged parallel to the axis with regard to one of the transmission output shafts, wherein one of the rotary gears meshes with one of the central gears and the other rotary gear is operatively connected with the other central gear with the interposition of an intermediate gear. For example, both of the rotary gears and the central gears are each configured as spur gears. Alternatively, only one of the rotary gears can be configured as a spur gear as well as the central gear meshing with them can be configured as a spur gear, and the other rotary gear and the corresponding central gear can be present in another embodiment, for example, configured as a bevel gear.

According to another embodiment, the differential is a bevel gear differential. The spur gear differential can have at least one, specifically two rotary gears, which each are non-rotatably connected to a separate shaft rotatably mounted to a rotary gear carrier and transversely arranged to one of the transmission output shafts, wherein each of the rotary gears meshes with one of the central gears. For example, both of the rotary gears and the central gears are each configured as a bevel gear. Alternatively, only one of the rotary gears can be configured as a bevel gear as well as the central gear meshing with them can be configured as a bevel gear, and the other rotary gear and the corresponding central gear can be present in another embodiment, for example, configured as a spur gear.

A possible embodiment of the parking brake system comprises an electronic control device for driving, specifically for controlling and/or adjusting the at least one drive of the drive train, as described above, specifically for controlling and/or adjusting at least one electromotive drive, wherein the control device and the drive are configured for setting, specifically continuously adjusting, a braking force actuated by the first brake element and the second brake element of the drive train, as described above, according to one or more set values. For example, the set values include or are based on information about the inclination of the roadway and/or the friction value of the roadway surface and/or about the current driving or stationary state of the motorized vehicle and/or about parameters of the motorized vehicle, such as for example the load condition. Provided that the first brake element and/or the second brake element is a friction brake, a controlled opening or closing of the brake element and, consequently, a regulation of the braking force is thereby possible, for example, for a comfortable start-up of the motorized vehicle, specifically on an inclined roadway.

After configuring the parking brake system or another embodiment of the parking brake system, an electronic control device for driving, specifically controlling and/or adjusting the drive, as described above, for the first brake element of the drive train, as described above, is provided, wherein the control device is configured for activating the parking lock function of the transmission, as described above, when the drive for the first brake element is actuated. The electronic control device can be the electronic control device described above. As a result, a parking brake system is implemented, by means of which parking braking can easily be performed, which has a blocking effect on both vehicle wheels input-connected to the differential.

After configuring the parking brake system or another embodiment of the parking brake system, an electronic control device for driving, specifically controlling and/or adjusting the drive, as described above, for the first brake element of the drive train, as described above, is provided, wherein the control device is configured for activating the parking lock function of the transmission, as described above, when the drive for the first brake element is actuated. The electronic control device can be the electronic control device described above. This measure is also provided to implement a parking brake system, by means of which parking braking can easily be performed, which has a blocking effect on both vehicle wheels input-connected to the differential.

Another aspect of the invention pertains to a method of operating the parking brake system described above. It is provided in a possible embodiment of the method that the parking lock function of the transmission is activated by means of the control device, if actuation of the drive for the first brake element is ascertained or imminent, for example, to lock or set or block one of the transmission output shafts of the differential by means of the first brake element. Specifically, the transmission input of the differential is locked or set or blocked by activating the parking lock function. As a result, parking braking can easily be performed, which has a blocking effect on both vehicle wheels input-connected to the differential.

Additionally or alternatively, it may be provided in an embodiment of the method that the drive for the first brake element is controlled by means of the control device to actuate the first brake element, if activation of the parking lock function of the transmission is ascertained or imminent. Specifically, one of the transmission output shafts of the differential is locked or set or blocked, if activation of the parking lock function of the transmission is ascertained or imminent. For example, the transmission input of the differential is or will be locked or set or blocked by activating the parking lock function. This measure is also provided to easily implement parking braking, which has a blocking effect on both vehicle wheels input-connected to the differential.

According to another aspect of the invention, a motorized vehicle is provided, which includes at least one of the embodiments described above and/or configurations of the parking brake system and/or at least one of the embodiments described above and/or configurations of the drive train. For example, the differential of the drive train is an axle differential of the front axle or the rear axle of the motorized vehicle. The transmission of the drive train is input-connected to a drive machine and the transmission output shafts of the differential are each in-put connected to a vehicle wheel. The differential can be an equalizing gear or a transfer gear. Specifically, the parking brake system can be operated in a motorized vehicle according to the method described above.

According to another aspect of the invention, the use of at least one of the embodiments described above and/or configurations of the drive train is provided to perform parking braking action with the motorized vehicle, specifically with the motorized vehicle described above.

### BRIEF DESCRIPTION OF THE FIGURES

Additional details and characteristics of the invention stem from the following description of several exemplary embodiments based on the drawing. It is shown in

FIG. 1 a possible embodiment of a drive train for a motorized vehicle with a transmission, a differential, and a parking brake system using the transmission and the differential in a schematic diagram,

FIG. 2 another possible embodiment of a drive train for a motorized vehicle with a transmission, a differential, and a parking brake system using the transmission and the differential in a schematic diagram,

FIG. 3 a possible embodiment of a drive train for a motorized vehicle with a transmission, a differential, and a parking brake system using the transmission and the differential in a schematic diagram, and

FIG. 4 another possible embodiment of a drive train for a motorized vehicle with a transmission, a differential, and a parking brake system using the transmission and the differential in a schematic diagram.

### DETAILED DESCRIPTION

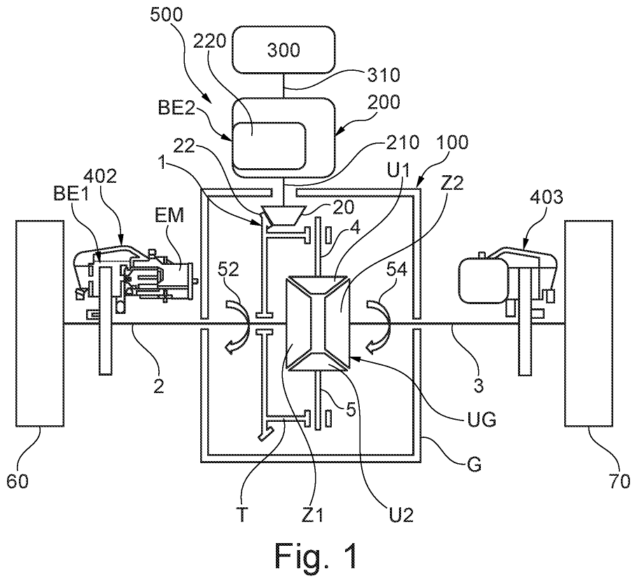

FIG. 1 shows a drive train 500 for a motorized vehicle as an example and simplified. The drive train 500 includes a transmission 200 drivingly couplable to a drive machine 300 and a differential 100 operatively connected or connectable to a output shaft 210 of the transmission 200. The drive machine 300 can be an internal combustion engine or an electric motor or another drive machine for moving the motorized vehicle. For force transmission of the drive machine 300 to the transmission 200, an output shaft 310 of the drive machine 300 is input-connected or input-connectable to the input of the transmission 200, specifically of an input shaft.

The transmission 200 is designed to cause different transmission ratios between its input or input shaft and its output or output shaft or output shaft 210. For example, the transmission 200 is an automatically operable transmission, specifically an automatic transmission or a semiautomatic transmission. The transmission 200 can have several (not shown in FIG. 1) switching elements, whose selective switching causes different transmission ratios between the input of the transmission 200 and its output shaft 210. The transmission 200 preferably has a parking lock function 220. For example, the parking lock function 220 is a mechanical lock, specifically a rotation lock, of the output shaft 210. The parking lock function can be achieved by actuating a selector lever by placing the selector lever to the adjustment position “P”. The parking lock can be the common parking lock of an automatic transmission.

The differential 100 is, for example, an axle differential. and can form a rear axle differential or a front axle differential. The differential 100 includes a transmission housing G, a transmission input 1, two transmission output shafts 2, 3, and a rotary gear transmission UG for distribution of a propulsion power affecting the transmission input 1 to the transmission output shafts 2, 3, for example, for equalization of the rpm difference between the transmission output shafts 2, 3, for example, when the motorized vehicle is cornering. The transmission input 1 is in drive connection to the transmission 200, for example, when the output shaft 210 of the transmission 200 acts upon a mating gear 22 allocated to the transmission input 1 via a drive gear 20, specifically a bevel gear or spur gear. The transmission output shafts 2 and 3 are each input-connected or input-connectable to a vehicle wheel 60 or 70. Arrows 52 and 54 point at the directions of rotation of the transmission output shafts 2, 3, or of the vehicle wheels 60 and 70 attached to them in a driving state.

Preferably, the rotary gear transmission UG has at least four transmission elements, of which two transmission elements are configured as a central gear Z1 or Z2, at least one, preferably two transmission elements as a rotary gear U1 or U2, and one transmission element as a rotary gear carrier T. The rotary gear carrier T is preferably coupled with the transmission input 1. For this reason, the mating gear 22 is non-rotatably connected or moulded to the rotary gear carrier T, for example. Preferably, one of the central gears Z1, Z2 is each coupled with, specifically non-rotatably connected to one of the transmission output shafts 2, 3. Preferably, the rotary gear U1 is engaged with the central gear Z1 and the rotary gear U2 with the central gear Z2, wherein the rotary gears U1, U2 are each rotatably mounted to the rotary gear carrier T. Preferably, the rotary gear carrier T in turn is pivotably resting against at least one of the transmission output shafts 2, 3, for example, against the transmission output shaft 2. The rotary gear transmission UG can be configured as a bevel-gear transmission. Preferably, the central gears Z1 and Z2 each are then configured as a bevel gear and also the rotary gears U1 and U2 each as a bevel gear. Preferably, the rotary gears U1 and U2 each are non-rotatably connected to a separate shaft 4 or 5 rotatably mounted to the rotary gear carrier T and transversely arranged to one of the transmission output shafts 2, 3.

A wheel brake 402, 403 each is allocated to the transmission output shafts 2, 3. The wheel brakes 402 and 403 are an integral part of a service brake system, for example, to be able to decelerate the motorized vehicle while driving. The wheel brakes 402 and 403 are preferably arranged close to the vehicle wheels 60, 70. Preferably, the wheel brakes 402 and 403 are configured as a disc brake, for example, as a floating-caliper disc brake or a fixed-caliper disc brake.

The drive train 500 is configured to take part in performing parking brakings or emergency brakings in connection with the parking brake system. For this reason, the drive train 500 has two brake elements, of which a first brake element BE1 is used for locking one of the transmission output shafts 2, 3 of the differential 100, specifically of the transmission output shaft 2, and a second brake element BE2 is used for locking the transmission 1 of the differential 100. At the drive train 500, the first brake element BE1 is allocated to one of the wheel brakes 402, 403, specifically the wheel brake 402. For example, the wheel brake 402 is a disc brake of the type floating-caliper disc brake or fixed-caliper disc brake with a caliper-integrated parking brake. There, parking braking or emergency braking with regard to the corresponding vehicle wheel 60 is performed by means of the first brake element BE1 with the aid of individual or several integral parts of the service brake provided in the wheel brake 402. Preferably, a drive, specifically an electromotive drive EM, is provided for actuating the first brake element BE1. Preferably, the electromotive drive EM is allocated to the wheel brake 402 and arranged fixed to a housing with regard to the vehicle chassis and/or the housing of the drive train and/or an integral part of the axle of the motorized vehicle.

By using the second brake element BE2 for locking the transmission input 1 of the differential 100, the other one of the wheel brakes 402, 403, for example, the wheel brake 403, can be equipped without an additional parking brake function. For example, the wheel brake 403 is then exclusively provided for service braking and, consequently, can be configured exclusively as a service brake. However, during parking braking operation, the transmission output shaft 3 allocated to the wheel brake 403 or the corresponding vehicle wheel 70 is also blocked. Inherent in the system, this is due to the differential 100, where, inherent in the system, specifically due to a self-locking feature of the rotary gear transmission UG, the transmission output shaft 3 is fixed, if the transmission output shaft 2 and the transmission input 1 are locked by means of the brake elements BE1, BE2.

With the drive train 500, the transmission 200 is used for locking the transmission input 1. There, the second brake element BE2 is allocated to the transmission 200 and an integral part of the parking lock function 220 of the transmission 200 or is formed by the parking lock function 220 of the transmission 200. In this application case, the locking of the output shaft 210 of the transmission 200 is consequently used to lock the transmission input 1 of the differential 100. For example, the parking braking or emergency braking can then happen in such a way that the parking lock function 220 of the transmission 200 is self-activated, if actuation of the electromotive drive EM is noticed or initiated for the first brake element BE1.

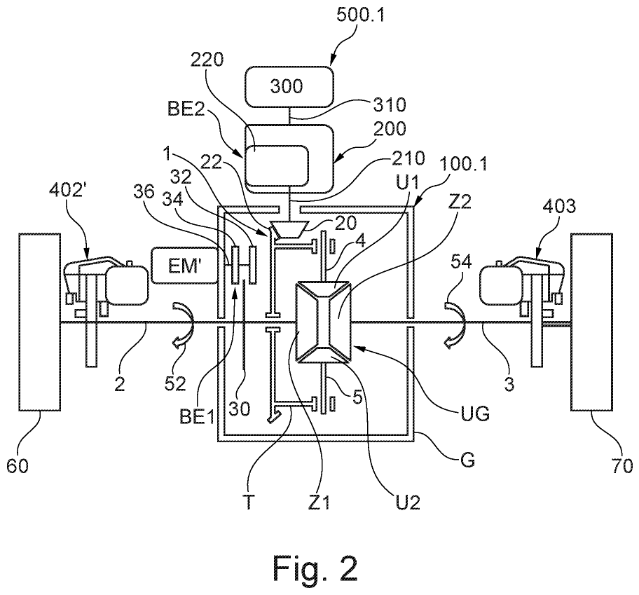

FIG. 2 shows another possible embodiment of a drive train 500.1 for a motorized vehicle. Integral parts of the drive train 500.1 of FIG. 2, which are identical in structure or function to the integral parts of the drive train 500 of FIG. 1, have the same reference signs; consequently, it is referred to the description for the drive train 500 of FIG. 1.

Among other things, the drive train 500.1 of FIG. 2 differs from the drive train 500 of FIG. 1 regarding the differential. With the drive train 500.1 of FIG. 2, a differential 100.1 is provided, which, among other things, differs from the differential 100 of the drive train 500 of FIG. 1 by allocating the first brake element BE1 to the differential 100.1. Consequently, a wheel brake 402′ is provided with the drive train 500.1, which, for example, is only configured for performing a service brake function in line with the wheel brake 403, therefore can be equipped without a parking brake function. Preferably, the first brake element BE1 is arranged within the transmission housing G of the differential 100.1 and is protected from external forces by the transmission housing G acting as an enclosure.

For example, the transmission output shaft 2 and, as a result, the central gear Z1 operatively connected to it can be operatively connected, specifically non-rotatably connected, to the transmission housing G by the first brake element BE1. In addition, the first brake element BE1 can be a frictionally engaged brake element, for example, as part of a friction brake, specifically a fixed-caliper disc brake or a floating-caliper disc brake. In addition, the first brake element BE1 can have at least one friction surface non-rotatably arranged with regard to the transmission housing, wherein a counter friction surface is allocated to the transmission output shaft 2. By friction contact of the friction surface against the counter friction surface, a deceleration and/or locking of the transmission output shaft 2 against the transmission housing G is achieved. The counter friction surface allocated to the transmission output shaft 2 can be configured at a material section 30, which is non-rotatably connected or moulded to the transmission output shaft 2. Preferably, the material section 30 is configured disc-shaped, for example, like a brake disc.

For example, the friction surface can be moved in an axial direction and/or parallel to the axis with regard to at least one of the transmission output shafts 2, 3 by configuring the friction surface, for example, at an axially moveable piston 32 so that there is friction contact against the counter friction surface by moving the friction surface in an axial direction. In addition, an additional friction surface can be provided, which, for example, is configured at another piston 34. The additional friction surface can be arranged opposite to the friction surface so that the material section 30 is located between the friction surface and the additional friction surface and can be brought into friction contact against them.

Preferably, a drive, specifically an electromotive drive EM′, is provided for actuating the first brake element BE1. Preferably, the electromotive drive EM′ is motion-coupled with the first brake element BE1, specifically with a friction surface, by means of a transmission element 36 so that the at least one friction surface can be axially moved by the electromotive drive EM′. The electromotive drive EM′ is fixed to a housing with regard to the transmission housing G, for example, attached on the outside of the transmission housing G. Preferably, the electromotive drive EM′ is a controllable and/or adjustable electric motor, by which the braking power affecting the first brake element BE1 is variable, specifically continuously variable.

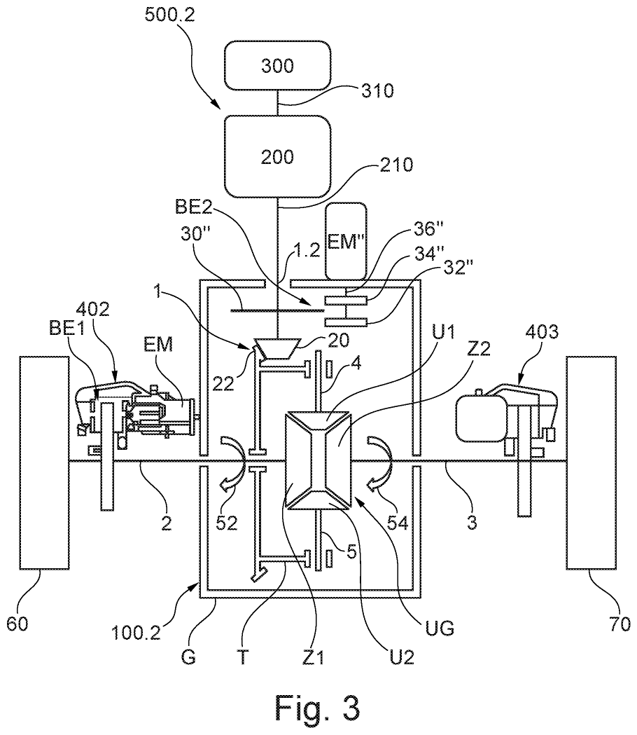

FIG. 3 shows yet another embodiment of a drive train 500.2. Integral parts of the drive train 500.2 of FIG. 3, which are identical in structure or function to the integral parts of the drive train 500 of FIG. 1, have the same reference signs; consequently, it is referred to the description for the drive train 500 of FIG. 1.

Among other things, the drive train 500.2 of FIG. 3 differs from the drive train 500 of FIG. 1 in the differential. With the drive train 500.2 of FIG. 3, a differential 100.2 is provided, which, among other things, differs from the differential 100 of the drive train 500 of FIG. 1 by allocating the second brake element BE2 to the differential 100.2. Preferably, the second brake element BE2 is arranged within the transmission housing G of the differential 100 and is protected from external forces by the transmission housing G acting as an enclosure.

With the transmission 100.2, the transmission input 1 or a transmission input shaft 1.2 of the differential 100.2 can be operatively connected, specifically non-rotatably connected, to the transmission housing G by the second brake element BE2. In addition, the second brake element BE2 can be a frictionally engaged brake element, for example, as part of a friction brake, specifically a fixed-caliper disc brake or a floating-caliper disc brake. In addition, the second brake element BE2 can have at least one friction surface non-rotatably arranged with regard to the transmission housing, wherein a counter friction surface is allocated to the transmission input 1 or the transmission output shaft 1.2. By friction contact of the friction surface against the counter friction surface, a deceleration and/or locking of the transmission input 1 or transmission output shaft 1.2 against the transmission housing G is achieved. The counter friction surface allocated to the transmission output shaft 1 can be configured at a material section 30″, which is non-rotatably connected or moulded to the transmission output shaft 1 or the transmission output shaft 1.2. Preferably, the material section 30″ is configured disc-shaped, for example, like a brake disc.

For example, the friction surface can be moved in an axial direction and/or parallel to the axis with regard to the transmission input shaft 1.2 by configuring the friction surface, for example, at an axially moveable piston 32″ so that there is friction contact against the counter friction surface by moving the friction surface in an axial direction. In addition, an additional friction surface can be provided, which, for example, is configured at another piston 34″. The additional friction surface can be arranged opposite to the friction surface so that the material section 30″ is located between the friction surface and the additional friction surface and can be brought into friction contact against them.

Preferably, a drive, specifically an electromotive drive EM″, is provided for actuating the second brake element BE2. Preferably, the electromotive drive EM″ is motion-coupled with the second brake element BE2, specifically with a friction surface, by means of a transmission element 36″ so that the at least one friction surface can be axially moved by the electromotive drive EM″. The electromotive drive EM″ is fixed to a housing with regard to the transmission housing G, for example, attached on the outside of the transmission housing G. Preferably, the electromotive drive EM″ is a controllable and/or adjustable electric motor, by which the braking power affecting the second brake element BE2 is variable, specifically continuously variable.

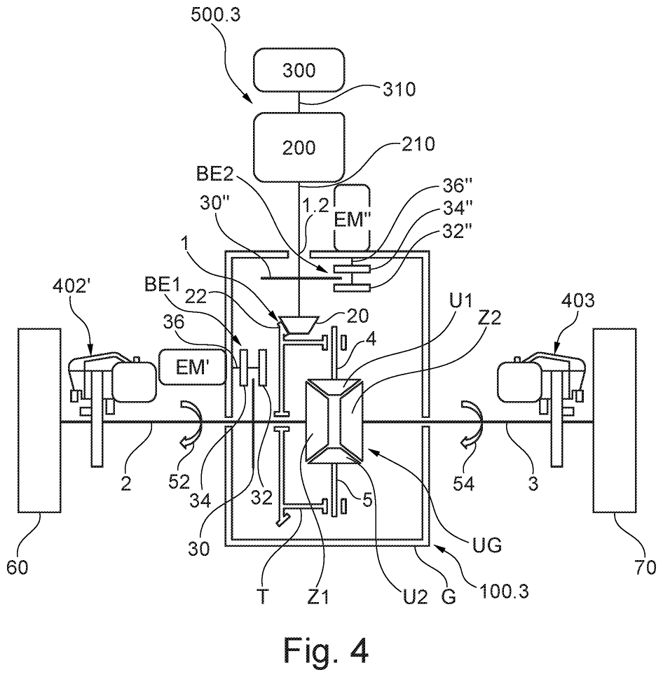

FIG. 4 shows another additional embodiment of a drive train 500.3 for a motorized vehicle. The drive train 500.3 has a differential 100.3, which is a combination of the differential 100.1 of FIG. 2 and of the differential 100.2 of FIG. 3 with regard to the first brake element BE1, the second brake element BE2 and the respectively corresponding electromotive drive EM′ or EM″; consequently, it is referred to the description of FIGS. 2 and 3.

For performing parking braking, the parking brake system prefers an electronic control device, by means of which the electromotive drive EM or EM″ for the first brake element BE1 and with regard to the second brake element BE2 the transmission 200 can be controlled at the drive train 500 of FIG. 1 or at the drive train 500.1 of FIG. 2 or by means of which the electromotive drive EM or EM′ for the first brake element BE1 and the electromotive drive EM″ for the second brake element BE2 can be controlled at the drive train 500.2 of FIG. 3 or at the drive train 500.3 of FIG. 4. Preferably, the control device and the electromotive drive EM or EM′ or EM″ are then configured for setting a braking power actuated by the brake elements BE1, BE2 according to one or more set values. By means of the control device, a specific proportion of braking power, for example, in its amplitude and/or over a predetermined period of time, can be specifically set so that a controlled braking of the motorized vehicle, for example, when decelerating to a standstill or when starting from the standstill, is enabled.

In FIGS. 1 to 4, the first brake element BE1 and the second brake element BE2 are each shown opened or deactivated. The parking brake system consequently does not lock.

In the description at hand, the reference to a specific aspect or a specific embodiment or a specific configuration means that a specific characteristic or a specific property, which is described in connection with the respective aspect or respective embodiment or the respective configuration, is at least included there, but do not necessarily have to be included in all aspects or embodiments or configurations of the invention. It is explicitly stated that each combination of the different characteristics and/or structures and/or properties, which are described in reference to the invention, are covered by the invention, unless this is explicitly or unequivocally refuted by the context.

The use of individual or all examples or of an exemplary expression in the text shall only illuminate the invention and shall not constitute any restriction with regard to the scope of the invention, if nothing else is claimed. Furthermore, no expression or phrasing of the description shall be understood in such a way that it is an element unclaimed, but essential for the practice of the invention.

1. A drive train for a motorized vehicle, the drive train including a transmission drivingly couplable with a prime mover and a differential operatively connected to a pinion shaft of the transmission, the transmission including a transmission housing, a transmission input, two transmission output shafts, and a planetary transmission, through which the transmission output shafts are located in operative connection to the transmission input, whereby the transmission input is operatively connected to the pinion shaft of the transmission and the transmission output shafts each with a automotive wheel are input-connectable, whereby the drive train has at least two brake elements for a parking brake, of which a first brake element is used for locking one of the transmission output shafts of the transmission and a second brake element for locking the transmission input of the transmission.

2. The drive train according to claim 1, whereby the two brake elements are exclusively intended for locking one of the transmission output shafts and the transmission input of the differential.

3. The drive train according to claim 1, whereby a wheel brake each is allocated to the transmission output shafts, which is set up for performing a service brake function, whereby one of the wheel brakes is allocated to the first brake element.

4. The drive train according to claim 3, whereby a drive, specifically an electromotive drive, is intended for actuating the first brake element, whereby the drive is allocated to a wheel brake.

5. The drive train according to claim 1, whereby the first brake element is set up to operatively connect the transmission output shaft to the transmission housing of the differential.

6. The drive train according to claim 5, whereby a drive, specifically an electromotive drive, is intended for actuating the first brake element, which is fixed to a housing with regard to the transmission housing of the differential.

7. The drive train according to claim 1, whereby the second brake element is allocated to the transmission and is an integral part of a parking lock function of the transmission or is configured by a parking lock function of the transmission.

8. The drive train according to claim 1, whereby the second brake element is set up to operatively connect the transmission input to the transmission housing of the differential.

9. The drive train according to claim 8, whereby a drive, specifically an electromotive drive, is intended for actuating the first brake element, which is fixed to a housing with regard to the transmission housing of the differential.

10. (canceled)

11. (canceled)

12. (canceled)

13. (canceled)

14. (canceled)

15. (canceled)

16. (canceled)
